(19) United States
(12) Patent Application Publication
(10) Pub. No.: US 2026/0238613 A1
(43) Pub. Date: Aug. 13, 2026

(54) FIREWALL SWITCHOVER MANAGEMENT IN TELECOMMUNICATIONS NETWORKS

(71) Applicant: BOOST SUBSCRIBERCO L.L.C., Englewood, CO (US)

(72) Inventors: Daljit Singh Lobana, Herndon, VA (US); Vamsi Moyya, Parker, CO (US)

(21) Appl. No.: 19/048,273

(22) Filed: Feb. 7, 2025

(51) Int. Cl. H04L 9/40; H04L 12/66; H04L 41/0663; H04L 43/10; H04L 45/02

(52) U.S. Cl. CPC H04L 63/0218; H04L 41/0663; H04L 43/10; H04L 45/02; H04L 12/66

(57) ABSTRACT

Systems and methods of switchover management in a network gateway comprise and/or utilize an internet gateway configured to receive a data stream from an external network; a network router configured to transmit the data stream to an internal network; a first firewall and a second firewall connected by a communication link and disposed in parallel between the internet gateway and the network router; and a route server configured to: receive route advertisements from the first firewall, update a routing table to direct a data packet of the data stream from the internet gateway to the first firewall, and in response to a determination that the first firewall suffers a failure condition: begin receiving the route advertisements from the second firewall, and update the routing table to direct the data packet from the internet gateway to the second firewall.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods in a telecommunications or other network to provide faster failover between firewalls, such as paired active/passive firewalls.

According to one aspect of the present disclosure, a network gateway is provided. The network gateway comprises an internet gateway configured to receive a data stream from an external network; a network router configured to transmit the data stream to an internal network; a first firewall and a second firewall connected by a communication link and disposed in parallel between the internet gateway and the network router; and a route server configured to: receive route advertisements from the first firewall, update a routing table to direct a data packet of the data stream from the internet gateway to the first firewall, and in response to a determination that the first firewall suffers a failure condition: begin receiving the route advertisements from the second firewall, and update the routing table to direct the data packet from the internet gateway to the second firewall.

According to another aspect of the present disclosure, a method of managing communications through a network gateway is provided. The method comprises receiving, by an internet gateway, a data stream from an external network; receiving, by a route server operatively connected to a first firewall and a second firewall, route advertisements from the first firewall, wherein the first firewall and the second firewall are connected by a communication link; updating, by the route server, a routing table to direct a data packet of the data stream from the internet gateway to a network router via the first firewall; in response to a determination that the first firewall suffers a failure condition: beginning to receive, by the route server, the route advertisements from the second firewall, and updating, by the route server, the routing table to direct the data packet from the internet gateway to the network router via the second firewall; and selectively transmitting, by the network router, the data stream to an internal network.

According to another aspect of the present disclosure, a non-transitory computer-readable medium is provided. The non-transitory computer-readable medium stores instructions that, when executed by at least one processor of a route server operatively connected to a first firewall and a second firewall, cause the route server to perform operations comprising: receiving route advertisements from the first firewall; updating a routing table to direct a data packet from an internet gateway to a network router via the first firewall; and in response to a determination that the first firewall suffers a failure condition: beginning to receive the route advertisements from the second firewall, and updating the routing table to direct the data packet from the internet gateway to the network router via the second firewall.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of a gateway configuration in accordance with a comparative example.

FIG. 4 illustrates an example of a gateway configuration in accordance with various aspects of the present disclosure.

FIG. 5 illustrates an example of a firewall switchover method in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The systems and methods set forth herein may be implemented on a telecommunications network in compliance with any telecommunication standard or group of standards; for example, fourth-generation (4G) network standards such as Long Term Evolution (LTE) and/or fifth-generation (5G) network standards such as New Radio (NR). In an example implementation, the wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a cloud-native 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

For voice communications, including Voice over LTE (VoLTE) using 5G networks, Voice over Wi-Fi (VoWi-Fi) using wireless internet networks, and Voice over NR (VoNR) using 5G networks, an Internet Protocol (IP) Multimedia Subsystem (IMS) framework may be provided. Collectively, these may referred to as Voice over IMS (VoIMS). By using VoIMS technologies, communications are routed via an IMS Core such that connections can be established and maintained between users of a first network and users of a second network, even if the second network is different from the first network, and even if the second network is based on a different architecture than the first network (e.g., between NR users and LTE users).

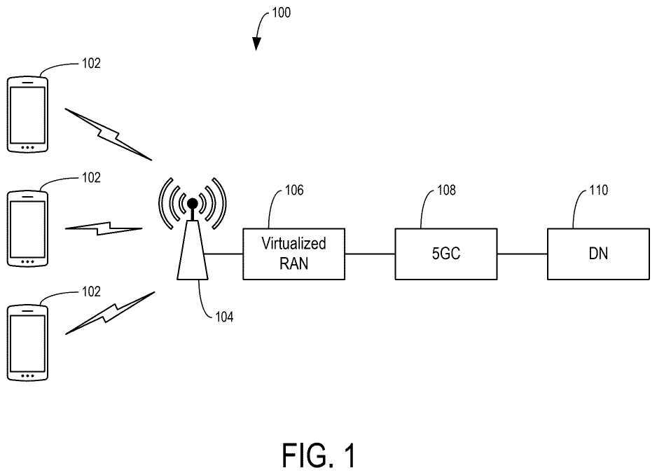

FIG. 1 illustrates an example of a telecommunications network 100 in accordance with various aspects of the present disclosure. In the telecommunications network 100 of FIG. 1, a plurality of UEs 102 are connected to a wireless access point 104, which in turn is connected to a set of virtualized RAN components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (APs), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of a group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

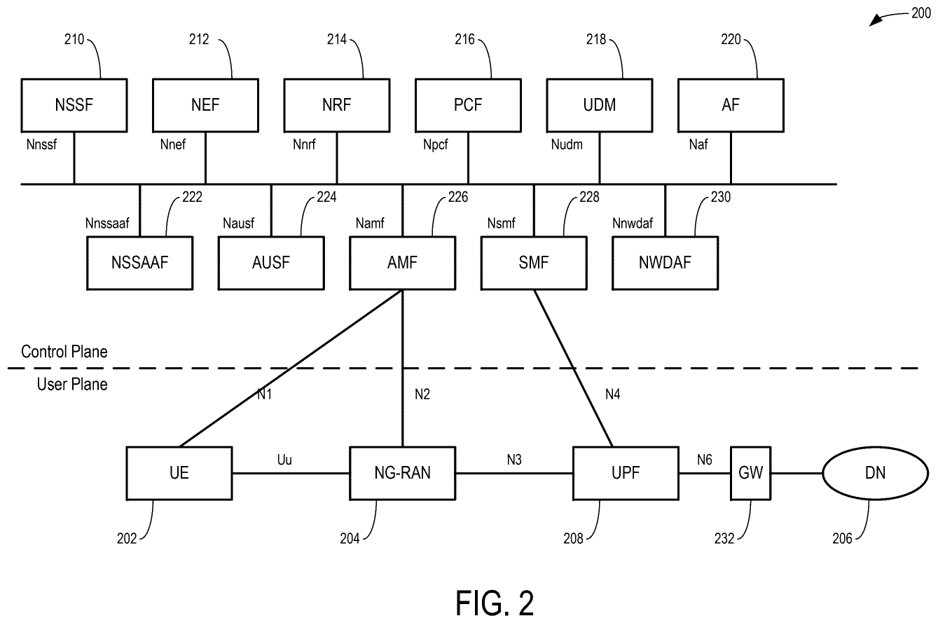

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 includes an infrastructure domain, which is divided between a control plane (CP) and a user plane (UP). The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1). For ease of illustration, FIG. 2 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet). The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QoS) assurance.

The CP NFs include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The PCF 216 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF directly influences QoS and subscriber spending limits, and as a result plays a role in the enhanced policy management and control capabilities of the 5G network.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

The NWDAF 230 is a CP function that collects data from pertinent network infrastructure relevant to a customer's services, including user equipment (device), network functions, network operations and administration, cloud, and edge that can be used for data analytics and insights. It is a unique standalone 5G network function that exposes full visibility to network performance and operations as they relate to a customer's key performance indicators (KPIs).

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Npcf for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206. Any of the above-described interfaces may be an SBI interface (e.g., an http2 based interface).

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the data network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc. ; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

In the SBA 200 shown in FIG. 2, the NG-RAN 204 may include some or all of the virtualized RAN components 106 illustrated in FIG. 1. Thus, the NG-RAN 204 may include at least one CU, at least one DU configured to operate under the control of one or more of the at least one CU, and at least one RU configured to operate under the control of one or more of the at least one DU. For example, each CU in the NG-RAN 204 may control a plurality of DUs, each of which in turn may control a plurality of RUs. Each RU may be operatively connected to a power amplifier and transmission elements (e.g., antennae) configured to cooperate to transmit signals to connected UEs 202 according to a transmission schedule.

In examples, the SBA 200 may be applicable to a particular cloud computing region. For example, as noted above, one instance of the SBA 200 may exist within a first geographical region (e.g., the northeastern United States) while another instance of the SBA 200 may exist within a second geographical region (e.g., the western United States). In this implementation, the above described NFs may be embodied in the form of computing nodes in data centers located within the corresponding geographical region. Thus, the first instance of the SBA 200 may be implemented by computing nodes in one or more data centers physically located in the northeastern United States, the second instance of the SBA 200 may be implemented by computing nodes in one or more data centers physically located in the western United States, and so on. Within each instance of the SBA 200, the computing nodes may be configured to implement at least instance of each of the above-described NFs.

As illustrated in FIG. 2, a gateway 232 may be disposed between the components of the SBA 200 and the data network 206 (and, in particular, between the UPF 208 and the data network 206). While FIG. 2 illustrates the gateway 232 as being separate from the UPF 208, in some implementations the gateway 232 and the UPDF 208 may be combined. In some implementations, the gateway 232 may be implemented as a virtual private cloud (VPC) component. The gateway 232 allows for control of communications to/from the UPF 208 and provides a mechanism for implementing several features in the network, such as security and access control features. For example, the gateway 232 may include one or more firewalls.

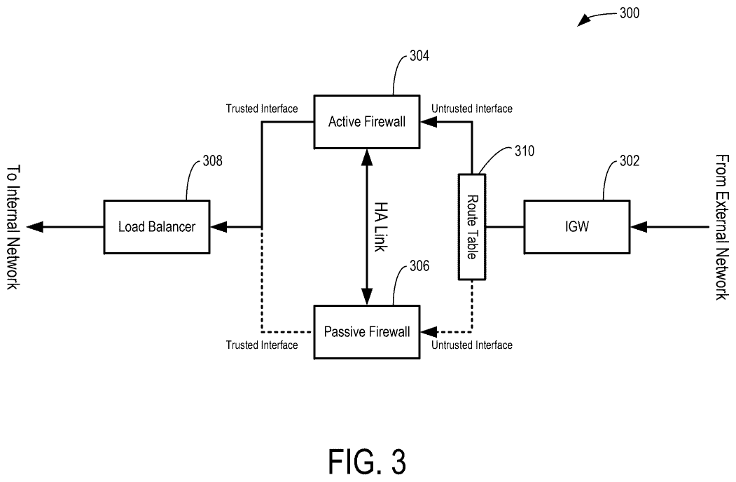

FIG. 3 illustrates an example gateway 300 in accordance with a comparative example. The gateway 300 may be an example of how the gateway 232 is implemented according to comparative methodologies. The comparative gateway 300 includes an Internet gateway (IGW) 302, two firewalls 304 and 306, and a load balancer (LB) 308. The two firewalls 304 and 306 are implemented as a “high availability” (HA) pair. In the two-firewall grouping shown in FIG. 3, firewall 304 is the active firewall and firewall 306 is the passive firewall. The firewall 304 and the firewall 306 are connected by an HA link, which may include a dedicated control link and a dedicated data link. The control link may be used to exchange control information, synchronize changes between the firewalls 304 and 306, and the like. The data link may be used to synchronize sessions, forward operational information, and the like. The IGW 302 receives traffic from an external network and routes it to the active firewall (in the illustrated example, firewall 304) via an untrusted interface. The active firewall in turn routes the traffic to an internal network component, such as the LB 308, via a trusted interface. The LB 308 in turn forwards the traffic to its internal destination (e.g., a VMAS application).

In the illustrated example, the firewalls 304 and 306 are configured according to an active/passive HA mode. Thus, the active firewall (firewall 304) actively manages the traffic whereas the passive firewall (firewall 306) remains synchronized with the active firewall but is in a standby mode. Both firewalls 304 and 306 share the same configuration settings (e.g., the same IP address, etc.). The firewalls 304 and 306 communicate via the HA link, for example to send heartbeat polling messages, hello messages, and the like. These messages indicate to the passive firewall that the active firewall is operational. If a failure occurs in the active firewall, the passive firewall takes over the traffic management duties. This event is referred to herein as a “failover” or “switchover.”

However, according to the comparative implementation, failure of the active firewall results in an undesirably long traffic switchover time. For example, during normal operation, the firewall 304 continually transmits the heartbeat signal via the HA link to the firewall 306. When failure occurs, the heartbeat signal stops transmitting. The firewall 306 detects this failure and a switchover is initiated. The firewall 306 becomes active, assumes the configuration from the firewall 304, makes API calls to the cloud server (e.g., in AWS) to move the elastic IP from the firewall 304 to the firewall 306 on an external interface, and makes API calls to the cloud server to make changes in routing on an internal interface (e.g., the AWS VPC routing table 310). These changes in the AWS VPC routing table 310 are dependent on the code thereof, which may be written in a Lambda function. This delay is in addition to the heartbeat interval and various sources of holdup time based on the settings of the firewalls 304 and 306. This leads to a large increase in switchover times influenced by the cold start time of the Lambda function, which in some comparative implementations may be as long as 33 seconds.

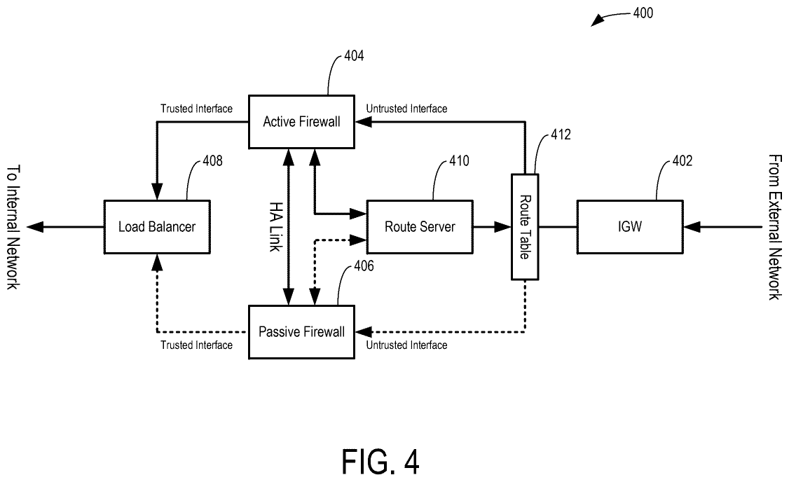

The present disclosure addresses these and other shortcomings in the comparative example by, for example, using Border Gateway Protocol (BGP) peering and introducing a Route Server to reduce the switchover time. In example implementations of the present disclosure, the switchover time may be reduced to less than 10 seconds (and, in some instances, to less than 3 seconds). FIG. 4 illustrates an example gateway 400 according to the present disclosure. The gateway 400 is an example implementation of the gateway 232 of FIG. 2. As with the comparative gateway 300, the gateway 400 of the present disclosure is provided between an external network (e.g., a wide area data network, such as a 5G data network or the Internet) and an internal network (e.g., an enterprise network). The gateway 400 includes an IGW 402, two firewalls 404 and 406, and an LB 408.

The IGW 402 is an example of an internet gateway, and is configured to receive a data stream from an external network (e.g., an untrusted network, such as the Internet or a cellular data network). The firewalls 404 and 406 may be implemented as an HA pair, with the firewall 404 initially acting as the active firewall and the firewall 406 initially acting as the passive firewall. The firewalls 404 and 406 are connected by a communication (e.g., an HA link) link that, as above, may include a control link and a data link. While FIG. 4 illustrates only two firewalls 404 and 406, the HA modality allows for multiple paired firewalls, and as such additional firewall pairs may be present, with each pair being internally connected by its own HA link. In such implementations, each pair may have its own version of the route server 410, or a single route server 410 may handle multiple firewall pairs. The LB 408 is an example of a network router, and is configured to transmit the data stream to an internal network (e.g., a trusted network, such as an enterprise network). The active firewall is configured to implement a network policy that controls forwarding of a data stream from the external network to the internal network. The network policy may include, without limitation, transmit/block policies (e.g., a policy to filter traffic), port selection/forwarding policies, protocol selection policies, and the like.

The gateway 400 further includes a Route Server (RS) 410 and operates with the firewalls 404 and 406 as BGP peers with the RS 410. In addition to the heartbeat and other signals communicated between the firewalls 404 and 406, the active firewall (e.g., firewall 404) further advertises routes to the RS 410. The RS 410 receives these advertisements and continually updates the VPC route table 412 to direct traffic to the active firewall. In one particular example, the RS 410 is configured to continually (e.g., at a predetermined interval) receive route advertisements from the firewall 404 and update a routing table 412 (e.g., a VPC RT) to direct data packets constituting the data stream from the IGW 402 to the firewall 404. In some implementations, the active and passive firewalls may be configured to communicate with the RS 410 using a Bidirectional Forward Detection (BFD) mechanism. In the BFD mechanism, the RS 410 and the firewalls 404 and 406 send heartbeat and/or hello signals to one another. The minimum interval between BFD communications between the RS 410 and the active firewall may be set by a network operator. The BFD signals are sent at a predetermined minimum interval (e.g., every 200 ms). The RS 410 may be configured to determine that the active firewall has failed if the heartbeat signal from the active firewall fails three times consecutively. By implementing the BFD mechanism, the RS 410 can further reduce the failover detection time (e.g., to less than one second).

At some point, in response to a determination that the firewall 404 suffers a failure condition (e.g., that the firewall 404 suffers an error that renders it incapable of successful operation, such as a host failure and/or a communication error), the RS 410 is configured to begin continually (e.g., at the predetermined interval) receive the route advertisements from the firewall 406 and update the routing table 412 to direct data packets constituting the data stream from the IGW 402 to the firewall 406. Thus, the firewall 406 becomes the active firewall and the firewall 404 becomes the passive firewall. This switchover operation may be repeated each time the active firewall suffers a failure condition. For example, in a state where the firewall 406 acts as the active firewall, and it is determined that the firewall 406 has suffered the failure condition, the route server 410 may be configured to begin receiving the route advertisements from the firewall 404 and update the routing table 412 to direct data packets constituting the data stream from the IGW 402 to the firewall 404. The failure condition may be determined as a result of the passive firewall monitoring the HA link, detecting that the heartbeat signal has stopped, and transmitting an indication that the active firewall has suffered the failure condition to the route server.

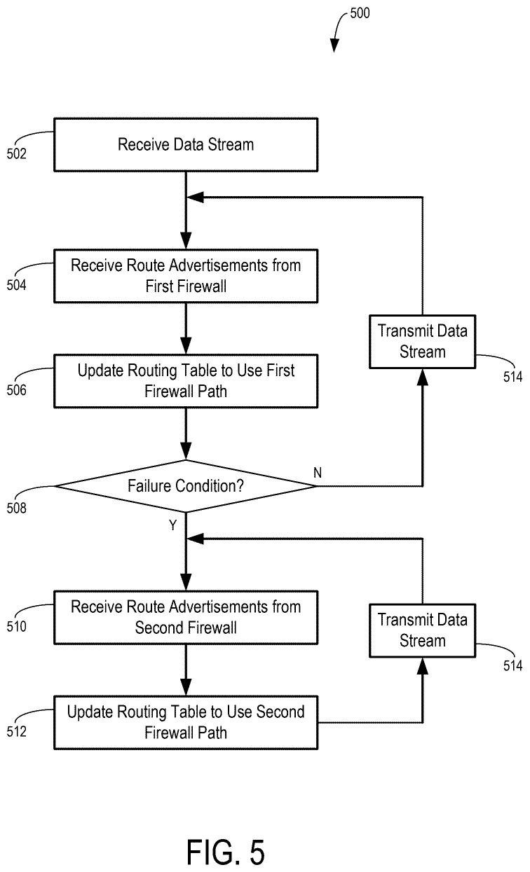

FIG. 5 illustrates an example method 500 of managing communications through a network gateway (e.g., a method of managing firewall switchover). For purposes of illustration, the method 500 will be described as being performed by components of the network gateway 400. Thus, in the following explanation, the firewalls are configured as an HA pair connected to one another via an HA link. However, in practical implementations the method 500 may be performed by any network gateway device including paired (passive/active) firewalls and a route server in communication with the paired firewalls.

The method 500 includes an operation 502 of receiving, by the IGW 402, a data stream from an external network (e.g., an untrusted network such as the Internet or a cellular data network). The data stream may include a sequence of data packets, and thus operation 502 may be performed continuously throughout the method 500. At operation 504 the route server 410 receives route advertisements from the active firewall (e.g., the firewall 404), and at operation 506 the route server 410 updates a routing table 412 to direct data packets of the data stream from the IGW 402 to the LB 408 via the active firewall. Operations 504 and 506 may be performed continually (e.g., a predetermined intervals) during the method 500.

At operation 508, it is determined whether a failure condition has occurred. As part of operation 508, during operation of the gateway 400 the active firewall may be configured to transmit a heartbeat signal to the passive firewall. The passive firewall may monitor a communication link from the active firewall for the heartbeat signal and, based on the presence, absence, or character of the heartbeat signal and make a determination as to whether the active firewall has suffered the failure condition. If the active firewall does suffer failure, the passive firewall may transmit the determination to the route server 410.

Thus, if failure occurs, at operation 510 the route server 410 begins receiving the route advertisements from the second firewall and at operation 512 the route server 410 updates the routing table 412 to direct the data packet from the IGW 402 to the LB 408 via the second firewall. Operations 510 and 512 may be performed continually (e.g., at the predetermined intervals). At some later point, a converse operation to operation 508 may be performed. In the converse operation, it is determined whether a failure condition has occurred. As part of operation 508, during operation of the gateway 400 the active firewall may be configured to transmit a heartbeat signal to the passive firewall. The passive firewall may monitor a communication link from the active firewall for the heartbeat signal and, based on the presence, absence, or character of the heartbeat signal and make a determination as to whether the active firewall has suffered the failure condition. If the active firewall does suffer failure, the passive firewall may transmit the determination to the route server 410. The difference between the converse operation and operation 508 is in the identity of the active and passive firewalls. In operation 508, the active firewall is firewall 404, and in the converse operation, the active firewall is firewall 406.

These operations may be performed repeatedly during the continual operation 502 of receiving the data stream. For each portion of the data stream, an operation 514 is performed to transmit the data stream to an internal network (e.g., an enterprise network). Operation 514 is performed using the active firewall as determined by operations 504-512. Operation 514 may be performed in accordance with a network policy implemented by the active firewall. As noted above, the network policy may include, without limitation, transmit/block policies (e.g., a policy to filter traffic), port selection/forwarding policies, protocol selection policies, and the like.

To perform the systems and methods set forth herein, a computing device may be provided that includes at least one processor and a non-transitory computer-readable medium storing instructions that may be executed by the at least one processor to perform various operations, such as the operations of the method 500. In an example, the computing device is a route server (e.g., the route server 410). In another example, the computing device controls the route server to implement the method 500. Thus, the computing device may be implemented as part of a network gateway (e.g., the network gateway 400) disposed between the external network and the internal network or may be implemented as a device that controls the network gateway and/or its components.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A network gateway comprising:
an internet gateway configured to receive a data stream from an external network;
a network router configured to transmit the data stream to an internal network;
a first firewall and a second firewall connected by a communication link and disposed in parallel between the internet gateway and the network router; and
a route server configured to:
receive route advertisements from the first firewall,
update a routing table to direct a data packet of the data stream from the internet gateway to the first firewall, and
in response to a determination that the first firewall suffers a failure condition:
begin receiving the route advertisements from the second firewall, and
update the routing table to direct the data packet from the internet gateway to the second firewall.

2. The network gateway according to claim 1, wherein the first firewall and the second firewall are configured as a high availability (HA) pair, and the communication link is an HA link.

3. The network gateway according to claim 2, wherein the second firewall is configured to receive a heartbeat signal from the first firewall via the HA link.

4. The network gateway according to claim 2, wherein the second firewall is configured to:
determine that the first firewall suffers the failure condition by monitoring the HA link; and
transmit the determination that the first firewall suffers the failure condition to the route server.

5. The network gateway according to claim 1, wherein the internal network is an enterprise network.

6. The network gateway according to claim 1, wherein the external network is an untrusted network and the internal network is a trusted network.

7. The network gateway according to claim 1, wherein the route server is configured to receive a heartbeat signal from the first firewall according to a Bidirectional Forward Detection (BFD) protocol.

8. The network gateway according to claim 1, wherein:
prior to the determination that the first firewall suffers the failure condition, the first firewall is configured to forward the data stream to the network router in accordance with a network policy; and
after the determination that the first firewall suffers the failure condition, the second firewall is configured to forward the data stream to the network router in accordance with the network policy.

9. A method of managing communications through a network gateway, the method comprising:
receiving, by an internet gateway, a data stream from an external network;
receiving, by a route server operatively connected to a first firewall and a second firewall, route advertisements from the first firewall, wherein the first firewall and the second firewall are connected by a communication link;
updating, by the route server, a routing table to direct a data packet of the data stream from the internet gateway to a network router via the first firewall;
in response to a determination that the first firewall suffers a failure condition:
beginning to receive, by the route server, the route advertisements from the second firewall, and
updating, by the route server, the routing table to direct the data packet from the internet gateway to the network router via the second firewall; and
selectively transmitting, by the network router, the data stream to an internal network.

10. The method of claim 9, wherein the first firewall and the second firewall are configured as a high availability (HA) pair, and the communication link is an HA link.

11. The method of claim 10, further comprising transmitting a heartbeat signal from the first firewall to the second firewall via the HA link.

12. The method of claim 10, further comprising, by the second firewall:
determining that the first firewall suffers the failure condition by monitoring the HA link; and
transmitting the determination that the first firewall suffers the failure condition to the route server.

13. The method of claim 9, wherein the internal network is an enterprise network.

14. The method of claim 9, further comprising, after updating the routing table to direct the data packet from the internet gateway to the network router via the second firewall:
determining that the first firewall has recovered from the failure condition; and
in response to a determination that the second firewall suffers the failure condition:
beginning to receive, by the route server, the route advertisements from the first firewall, and
updating, by the route server, the routing table to direct the data packet from the internet gateway to the network router via the first firewall.

15. The method of claim 14, wherein the operation of determining that the first firewall has recovered from the failure condition comprises:
receiving, by the second firewall, a heartbeat signal from the first firewall; and
transmitting, to the route server, an indication that the first firewall has recovered from the failure condition.

16. The method of claim 9, wherein the operation of selectively transmitting the data stream to the internal network is performed in accordance with a network policy implemented by the first firewall or the second firewall.

17. The method of claim 16, wherein the network policy includes at least one of a transmit/block policy, a port selection policy, or a protocol selection policy.

18. A non-transitory computer-readable medium storing instructions that, when executed by at least one processor of a route server operatively connected to a first firewall and a second firewall, cause the route server to perform operations comprising:
receiving route advertisements from the first firewall;
updating a routing table to direct a data packet from an internet gateway to a network router via the first firewall; and
in response to a determination that the first firewall suffers a failure condition:
beginning to receive the route advertisements from the second firewall, and
updating the routing table to direct the data packet from the internet gateway to the network router via the second firewall.

19. The non-transitory computer-readable medium of claim 18, wherein the instructions, when executed by the at least one processor, cause the route server to perform operations further comprising:
instructing at least one of the first firewall or the second firewall to direct the data packet from the internet gateway to the network router in accordance with a network policy.

20. The non-transitory computer-readable medium of claim 18, wherein the data packet is a part of a data stream from an external network to an internal network, and wherein the route server is a part of a network gateway disposed between the external network and the internal network.
